(19) United States
(12) Patent Application Publication
(10) Pub. No.: US 2007/0031039 A1
(43) Pub. Date: Feb. 8, 2007

(54) Segmentation of digital images

(75) Inventors: William F. Gallafent, Bedfordshire (GB); Timothy Milward, Oxford (GB)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Bourbay Limited, London (GB)

(21) Appl. No.: 11/442,102

(22) Filed: May 26, 2006

(30) Foreign Application Priority Data
May 26, 2005 (GB) GB 0510792.5

(51) Int. Cl. G06K 9/34

(52) U.S. Cl. 382/173

(57) ABSTRACT

A method and system for segmenting a digital image, the digital image comprising at least some mixed pixels whose visual characteristics are determined by a mixture of the visual characteristics of part of two or more portions of the image A method comprises the steps of: selecting one or more pixels within a first portion of the image to define a first pixel selection; expanding the first pixel selection to define a second pixel selection corresponding to a first portion of the image; selecting one or more pixels within a second portion of the image to define a third pixel selection; expanding the third pixel selection to define a fourth pixel selection corresponding to a second portion of the image; making a determination as to how close together the second pixel selection and the fourth pixel selection are; and indicating to a user whether or not the second pixel selection and fourth pixel selection are sufficiently close that the pixels occurring in between the second pixel selection and the fourth pixel selection are pixels in a boundary portion of the image.

### REFERENCE TO RELATED APPLICATIONS

The present application claims priority to British Patent Application Serial No. GB 0510792.5 entitled “Assisted Selections with Automatic Indication of Blending Areas,” filed on May 26, 2005, which is herein incorporated by reference.

### FIELD OF THE INVENTION

This invention relates to digital image processing, and in particular to the process of segmenting digital images in which an image is separated into regions so that, for example, a foreground region may be separated from a background region.

### BACKGROUND OF THE INVENTIONS

One common type of digital image manipulation is the extraction of a foreground portion of the image from the background and overlaying the foreground onto a new background to generate a composite image. With this kind of process, blending calculations may be applied to regions of the image on the boundary between the foreground and background where the visual characteristics of pixels have contributions from both foreground and background objects. The blending calculations allow the contribution from the background to be removed when the foreground object is extracted, and then contributions from the new background added when the composite image is generated. Where a high degree of blending between the foreground and background occurs, the width of the blending region, or edge region, may be significant. For sharp edges, the edge region is narrower. Other types of manipulation include modifying the visual characteristics of one particular region of an image (such as foreground or background) only.

One way to facilitate this type of image manipulation is to generate an image mask. An image mask allows parameters such as an opacity value to be assigned to each pixel in the image. For example, pixels in a background region of the image may be assigned a fully transparent opacity, pixels in the foreground a fully opaque opacity, and pixels on the boundary an intermediate opacity.

In order to generate an image mask or perform other image processing, the image may be segmented to divide the image into regions representing, for example, background, foreground and edge regions. In one technique, a sample selection is made, for example by a user or automatically by a system, in a particular region. This initial selection is then expanded by a suitable method to fill the region in which the initial selection lies. This process may be repeated by making further sample selections in other regions of the image to produce a segmented image. Examples of making such a segmentation are described in our International patent application number PCT/GB2005/000798, incorporated herein by reference.

When using the techniques described above, the quality of the resulting segmentation depends on the sample selections made. If too small a selection is made then an incorrect segmentation of the image may result. This may result in turn in blending calculations not being applied properly or incorrect modification of the image. However, it may be difficult to determine when a sufficient selection has been made to produce a good segmentation. For example, a particular problem for inexperienced users is their tendency to select too much foreground and background, to ensure that their selections are sufficient. Such selections often allow foreground and background to abut one another, or to be very close together, leaving too little space in between to allow the discovery and processing of the edge region between the foreground and background. This can lead to overly sharp edges in the blended result. Other effects, such as pollution of the foreground with the original background colour, may also occur.

We have appreciated that the desirability of a system which allows segmentation of an image to be performed with minimal difficulty. We have also appreciated that it is useful to provide a user with an indication after a selection has been made as to whether that selection is suitable before a complete segmentation of the image is made.

### SUMMARY OF THE INVENTION

The invention is defined in the appended claim to which reference may now be directed. Preferred features are set out in the dependent claims.

In one aspect, the invention discloses methods and systems for segmenting a digital image, where the digital image comprises at least some mixed pixels whose visual characteristics are determined by a mixture of the visual characteristics of part of two or more portions of the image. The method comprising the steps of selecting one or more pixels within a first portion of the image to define a first pixel selection; expanding the first pixel selection to define a second pixel selection corresponding to a first portion of the image; selecting one or more pixels within a second portion of the image to define a third pixel selection; expanding the third pixel selection to define a fourth pixel selection corresponding to a second portion of the image; making a determination as to how close together the second pixel selection and the fourth pixel selection are; and indicating to a user whether or not the second pixel selection and fourth pixel selection are sufficiently close that the pixels occurring in between the second pixel selection and the fourth pixel selection are pixels in a boundary portion of the image.

### BRIEF DESCRIPTION OF THE FIGURES

FIG. 1 shows a portion of an image at the boundary between two regions (the black region and white region) which may be, for example, a background region and foreground region;

FIG. 2 illustrates graphically the values of the parameter D₁ for the pixels in the image with black indicating a parameter value of zero and grey indicating a non-zero value;

FIG. 3 illustrates graphically the values of the parameter D₂ for the pixels in the image, again with black indicating a parameter value of zero and grey indicating a non-zero value;

FIG. 4 is a graphical depiction of a multi-scale gradient calculation;

FIG. 5 is a schematic view of one embodiment of the present invention; and

FIGS. 6A-E are graphs of (A) color value, (B) color gradient, (C) color gradient magnitude, (D) 2^{nd} derivative and (E) second derivative magnitude versus position.

### DESCRIPTION OF PREFERRED EMBODIMENTS

The present invention may be implemented on any suitable computer system, such as the one illustrated schematically in FIG. 9, comprising a processor 1 for performing various digital image processing steps, a display 3 such as a monitor for displaying digital images and a user interface, and input devices 5 such as a keyboard and mouse to allow the user to control the user interface, make selections and input data.

In an exemplary system and method according to the invention, a digital image is segmented. The process uses two types of data. The first type comprises one or more selections of pixels made in the image, either by a user or automatically by the system. The second type of data includes data derived automatically from the image by the system representing the gradient or derivative at each pixel of the values representing the visual characteristics (such of colour) of each pixel. These two kinds of data are applied to generate a segmentation of the image.

The visual characteristics of each pixel may be represented by one or more parameters. For example, the colour of a pixel is typically represented by three parameters being the red, green and blue components (or hue, saturation or lightness values) of the colour. The values assigned to each parameter for each pixel determines the colour of each pixel. In a greyscale image, the colour is represented by a single parameter, intensity. Other parameters may be used to represent other visual characteristics such as texture. In this way, the visual characteristics of each pixel are represented by a set of one or more values, being the values of the parameters described above.

The gradient data used in the method is calculated using the values of the parameters for each pixel. First, one or more gradient values are calculated for each pixel. In one embodiment, for each pixel (in a two-dimensional pixel array) a value representing the derivative of one of the parameters in each of the horizontal and vertical directions is calculated. These two derivative values may be though of as the components of a two-dimensional vector, which may be referred to as a derivative vector. Then, the magnitude of the derivative vector is calculated. For example, if the components of the derivative vector have values x and y, then the magnitude may be calculated to be m₁=(x²+y^{y})^{1/2}. Similar magnitude values m₂, m₃, . . . etc. may be calculated for each pixel based on the derivative of the other parameters. Next, a single derivative parameter D₁ for each pixel may be calculated based on the individual derivative values m₁, m₂, . . . For example, in one example, the value of D₁ is the average value (such as mean or median value) of the values m₁, m₂, . . . Alternatively, the value of M may be determined to be the magnitude of the vector whose components are the values m₁, m₂, . . . so that D₁=(m₁²+m₂²+. . .)^{1/2}. In this way, an additional parameter D, is defined representing the variation of the visual characteristics of pixels at a particular pixel. A value for the parameter D₁ may be calculated for each pixel.

Next, a value representing the second derivative may be calculated for each pixel. In one embodiment, the second derivative data is derived from the values of the parameter D₁. For example, for each pixel, the gradient or derivative of the values of D₁ in both the horizontal and vertical directions is calculated. These two values may be thought of as the components of a vector. The magnitude of this vector may be denoted by D₂ which is an additional parameter representing the second derivative of the image at each pixel. A value of the parameter D₂ may be calculated for each pixel.

It is understood that the above method of calculating derivative data for an image is one specific example and that other ways of generating derivative data from the image may be used.

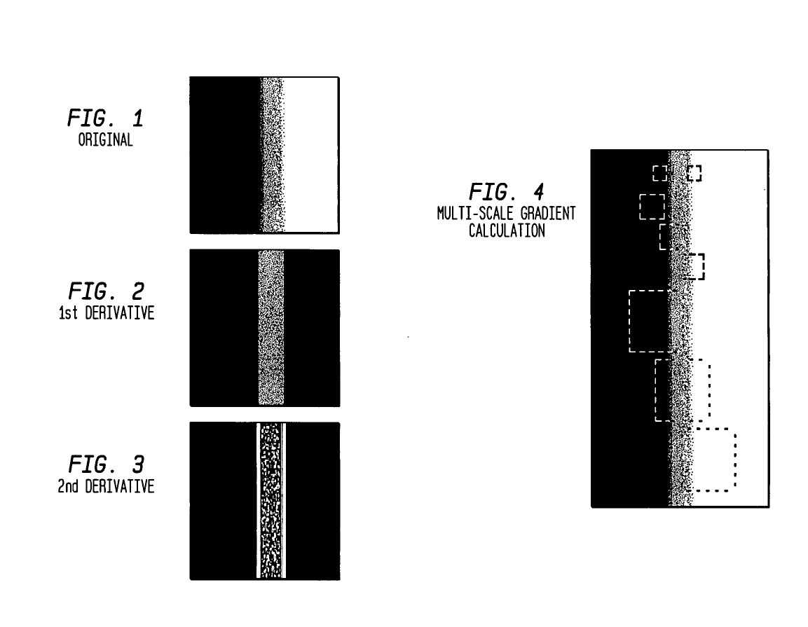

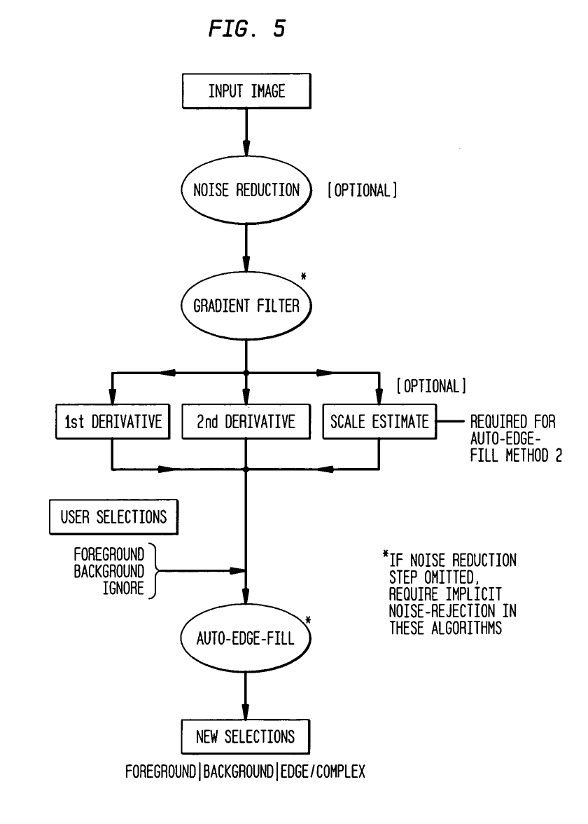

FIG. 1 shows a portion of an image at the boundary between two regions (the black region and white region) which may be, for example, a background region and foreground region. A degree of blending or blurring has occurred in the edge region between the foreground and background causing a variation in the intensity of the image in the edge region. It can be seen that this edge is not a perfectly sharp edge and so has a significant thickness.

FIG. 2 illustrates graphically the values of the parameter D₁ for the pixels in the image with black indicating a parameter value of zero and grey indicating a non-zero value. Since the intensity of pixels in both the foreground and background regions of the original image are relatively uniform, the value of D₁ in the foreground and background are substantially zero. In the edge region of the original image there is a gradual change in intensity as one moves from background to foreground which results in a non-zero and relatively constant value of D₁ in the edge region.

FIG. 3 illustrates graphically the values of the parameter D₂ for the pixels in the image, again with black indicating a parameter value of zero and grey indicating a non-zero value. In the foreground and background regions of the original image, the value of D₂ is substantially zero. Since the gradient in the edge region of the image is relatively uniform, the value of D₂ is also substantially zero in the edge region, with some noise caused by slight variations in the value of D₁. At the edges of the edge region, since there is a relatively sharp change in the value of D₁, this results in a non-zero value for D₂ at these points. This is illustrated by the two white stripes occurring at the edges of the edge region in FIG. 3.

It can be seen that the parameter D₁ may be used to discover edge regions in an image and that the parameter D₂ may be used to detect the edges of the edges which may be used in turn to determine the width of the edge regions of the image.

In one method to calculate the derivative value at a pixel, the values of the parameter within a set of pixels forming a square of length ‘I’ centred on the pixel in question may be determined. The smallest value is then subtracted from the largest value and the result divided by the length ‘I’. The size of ‘I’ may be, for example, a parameter in the system. It is understood that shapes other than squares may be used in this method. It can be seen that if the size of the area (such as a square) around a pixel changes, a different value of the derivative, in general, is calculated.

This method of calculating a derivative value may be used to calculate a value for each pixel representing in a broad sense the level of detail at each pixel such as the characteristic size of an edge. A pixel in the middle of the edge region shown in FIG. 1 is first considered, and its gradient value calculated by considering a region of pixels of size I in the vicinity of the pixel as above. If the region of pixels of size I is within the edge region then the calculated gradient will be a particular value. If the size of the area is increased so that ‘I’ increases, but remains within the edge region, then it can be seen that the difference between the highest and lowest values of the parameter in question will also increase. However, since the value of I (which the difference is divided by) has also increased, the difference in parameter values is normalised so that the resulting gradient value determined will be the same. However, if the size of the area is increase sufficiently so that part of it lies outside the edge region, it can be seen that, as I increases, the difference between the highest and lowest parameter values will remain the same because the parameter values outside the edge region are constant. However, since the value of I is still increasing, the calculated gradient value will decrease.

For each pixel in the image, by calculating the gradient using the method described above with increasing values of ‘I’ it is possible to determine the point at which the decrease in the calculated gradient value exceeds a threshold. The size of ‘I’ at which the calculated gradient value decreases by an amount greater than a threshold may be used as a measure of the width of an edge at he pixel. Such a measure may be referred to as a characteristic feature size. For wider edges, the characteristic feature size will be larger than that for narrower edges.

The threshold may be chosen such as to exclude small changes in the calculated gradient value due to noise in the data. The noise within image data may also be removed by any suitable smoothing technique. Suitable smoothing techniques are known to those skilled in the field of the invention. When data is smoothed to remove noise, the necessary size of the threshold may be lower.

In addition to the derivative data and characteristic feature space data mention above, the invention also uses data representing selection of pixels in the image by a user or automatically by the system.

The image may be presented to a user on a user interface and the system is configured to allow the user to select or paint an area of the image to select pixels in the image. This first selection should be made within a particular portion of the image such as the foreground or background portion. The system is then configured to expand this first selection to include all the pixels of whichever portion of the image contained the pixels originally selected. The expansion may be performed using any suitable method. One example is described in our International patent application number PCT/GB2005/000798. In this method, a grouping of colours (or other visual characteristics) is made so that each colour group contains a set of similar colours. Next, the set of colours present in the pixel selection made by the user is expanded to include all colours contained in those colour groups containing colours present in the original pixel selection. Then, the expanded pixel selection comprises all pixels having a colour contained in the expanded colour set. According to a related method, the expanded pixel selection is determined in a similar way to the first method except with the additional condition that the expanded pixel selection must be a contiguous region, and contiguous with the original user defined pixel selection.

In this way, if the user makes an initial selection, for example within the background region of the image, the expanded pixel selection will comprise substantially the whole of the background region. The expanded pixel selection derived from the first user selection may be referred to conveniently as pixel selection A. Each pixel within pixel selection A may be assigned a status according to which region (such as foreground or background) the pixels are located in.

Next, a second selection of pixels is made, either manually by the user or automatically by the system. The second selection should be made in a region of the image different to that in which the first selection was made. For example, if the first selection was made in the background then the second selection could be made in the foreground. The second selection is then expanded in a similar manner as with the first selection made. The expanded pixel selection derived from the second user selection may be referred to conveniently as pixel selection B. As with the first expanded selection, each pixel within pixel selection B may be assigned a status according to which region the pixels are in. The status of the second expanded selection will be different from the status of the first expanded selection.

Typically, there will exist a boundary layer between pixel set A and pixel set B which corresponds to an edge region where blending may occur.

For each pixel in the image within a set distance from selection B, the steps described below are carried out. The set distance may be, for example, a predetermined value, a user-defined value or a system calculated distance. Alternatively, the set distance may be the characteristic feature size value for a selected pixel on the boundary of B, or an average value of the characteristic feature sizes of several pixels on the boundary of B. The set of pixels within the set distance from B may be referred to as pixel selection C.

For each pixel in pixel selection C, the surrounding pixels are considered. For example, the characteristic feature size, ‘I’, is determined for a pixel P in C and those pixels within a distance ‘I’ from the pixel P (for example the set of pixels forming a square centred on the pixel P) are considered. If any of the pixels thus considered have been assigned a different status to those pixels in B then this indicates that the pixel selection A and pixel selection B are sufficiently close together in the vicinity of P that pixel P can be considered to be a boundary or edge region pixel. When this is the case, the pixel P may be denoted P′. If pixel selection A and pixel selection B are not sufficiently close together than this indicates that the selections made by the user are not sufficient to provide a good segmentation of the image.

If the pixel selections A and B are determined to be sufficiently close together then the pixels corresponding to the edge or boundary layer are assigned a status to indicate this. This assignment may be carried out in several different ways.

In a first method, an area around each pixel P′ is assigned an edge status. The particular area may be, for example, a predetermined sized area of a particular shape centred on P′. In one embodiment, the predetermined size may be the characteristic feature size value for pixel P′ or a predetermined multiple thereof.

In a second method, each pixel P in pixel selection C is considered in turn as described above and each pixel P′ is marked. Then, the set of marked pixels P′ is expanded using the second derivative data D₂. In particular, the set of pixels P′ are expanded in a contiguous manner until the edge of the boundary layer is encountered. As described above, local minima or maxima in the second derivative data indicates the presence of an edge of the edge region.

A similar expansion process may be carried out using the first and second user selections so that these selection are expanded in a contiguous manner until the edge of a boundary layer is encountered.

In one embodiment, the Watershed algorithm (known to those skilled in the art) may be carried out on the second derivative data, seeded by the pixel selection P′ and the first and second user selections.

When the user has made selections with in the image, for example in the foreground and the background, the system derives the corresponding image segment and determines how close together these are. If the segments are sufficiently close together then the boundary layer is assigned to an edge segment to complete the segmentation. However, if the foreground and background segments are not sufficiently close together, a visual or other indication may be made to the user prompting them to modify their selections. In this way, an inexperienced user can produce a good segmentation of the image with minimum effort. Since the user receives indications of when their selections are sufficient or not sufficient, the user can more easily learn what constitutes a good selection.

### EXAMPLE 1

In this example there are two aspects. The first is dependent only on the digital image data input, and consists of the gradient (first derivative) calculation, second derivative calculation and, optionally, scale estimate (which may be generated concurrently with the first or second derivative, or may be calculated subsequently by a separate process).

The second aspect depends also on input from the user, viz selections of foreground, background and irrelevant (ignore) pixels, and consists of the expansion of foreground and background selections according to data derived from the gradient image, and the selection as “edge” pixels of pixels found to be inside the extent of edges found between the foreground and background selections.

In order to provide best results for the gradient calculations, it is important that noise present in the data being analysed is minimized. This is required in order to allow calculations of first and second derivative to produce the most accurate possible results. The presence of noise in the image leads to erroneously high gradients near noisy pixels, meaning that small genuine gradients in the image are overwhelmed.

This may either be achieved explicitly by filtering the input to reduce noise before any other algorithm is applied to it, or implicitly by considering the noise level present in the data during the execution of each algorithm.

Standard methods used to explicitly reduce the noise content of the input data which are well suited to this application include Graduated Non Convexity, Median Filtering, Morphological Reconstruction, or simply scaling down the image, aggregating pixel values using mean or median averaging or some other down-scaling method such as bi-cubic interpolation or the Lanczos Scale Transform. Any other noise reduction method known to a person skilled in the art may be used.

Part 1—Automatically Generated Data:

The first information generated from the input data is a value for each pixel representing the gradient (first derivative) of the image at that point. There are many methods for calculating this, constituting a broad class of “edge detection” algorithms. The requirements for a method suitable for use in this context is that it has meaningful first and second derivatives with respect to position, i.e. the images of the first and second derivatives are amenable to having a clustering or segmentation algorithm such as the watershed applied to them; the application of such an algorithm will generate classes/clusters/segments which represent well the natural areas of uniform/similar first/second derivative in the image.

Methods which might be used for calculating this gradient (first derivative) step include Morphological Gradient [Soille], Local Linear Regression, Quadratic Regression, and possibly other localised regression methods such as Wavelet Regression, LOESS methods (local linear regression using a variable window size) [loess], other nonparametric regression techniques, or fitting splines to the data.

The basic data produced by the gradient filter represents the vector colour gradient in image space. In other words: Each pixel contains a colour value, which may be represented as three numbers (signifying values of e.g. Red, Green and Blue, or of Hue, Lightness and Saturation), or by another number of parameters describing the colour and/or other characteristics at that point. The image is an array of data of this type, such that every point in the image has a vector value in this space, usually its colour. Other parameters, either inherent in the original image data, or calculated from it, may also be used as elements in the vector stored for each pixel.

Then, using any standard mathematical gradient-finding technique, the gradient at a certain point may be calculated. It's useful to use a multi-scale method; to calculate the gradient at the point based on surrounding points taken from a window of several different sizes. The window size at which the gradient is maximised gives an indication of the width of the feature under the pixel (which may be an edge; this measure is required to perform some implementations of the second part invention—method B below, for example).

The calculation of the second derivative is done by applying the same algorithm applied to the original image to the first-derivative image.

A key requirement for the gradient calculation is that the method should produce output which can be used to calculate a scale measure, which of the scale of detail at each pixel. This provides a value for each pixel representing the approximate size, in pixels, of a given area of constant gradient centred on that pixel. Therefore, in flat areas the scale measure will be very large; in speckled areas small; at soft de-focussed edges larger than at sharply focussed edges.

The scale measure at a point thus describes the distance from that point for which the gradient is uniform within a certain tolerance.

If desired, to complement explicit noise reduction applied to the input, or in place of it, Implicit noise reduction in the gradient filter might be carried out by generating the first and second derivatives using a method which only considers a gradient significant when its magnitude exceeds that which could have been generated by noise.

A determination of the scale measure at a given point can be performed by using a method such as the multi-scale morphological gradient. By finding the window size N at which the morphological gradient over that window size, normalized by dividing by the window size, reaches a maximum, that value of N can be considered representative of the scale measure at that pixel.

Part 2—User Interaction, Selection Refinement, Edge Finding and Display.

Two example methods for using the data (first derivative image, second derivative image, scale measure image) calculated in Part 1 for each pixel to assist the user in making selections follow. Each requires the user to make some selection of foreground and background, which might be expanded automatically in some way before the method of this invention is applied.

### EXAMPLE APPROACH A

i. Perform a morphological watershed analysis or other clustering algorithm, in image-space, on the first derivative (the gradient) of the image, which is seeded with each of the Foreground, Background and Ignore sets of pixels. This generates an image-sized array, each point of which is assigned to a certain class. The pixels in the resulting classes therefore represent areas of FG/BG (for classes which grew from the FG/BG seeds), or edge/irrelevant (for classes which did not grow from FG/BG seeds).

Optionally, reassign the pixels in the image which are consequently associated with FG & BG (by becoming members of the seeded FG/ BG classes) the corresponding status, for subsequent processing (selections and blending) and for display to a user to indicate the effect of the automatic expansion process.

ii. Perform a watershed on the second derivative of the image, seeded with the pixels which fall on borders between FG and BG in the first-derivative image (i.e. pixels which are in a FG class in the clustering performed in i, but which have adjacent pixels which are in a BG class in that clustering, and similarly BG pixels from that clustering which have adjacent pixels in a FG class).

The classes in the 2nd derivative. image matching those “boundary” seeds, i.e. those classes in the segmentation of the 2nd derivative which grew from the FG/BG boundary pixels in the 1st derivative classification, constitute the boundary or transition areas in the image. These pixels are therefore assigned the appropriate “Mixed” status in the image.

This allows the subsequent application of a blending algorithm (an algorithm which calculates the true foreground colour of blended pixels, and their opacity) to all of these mixed pixels, as well as the display to the user of the location and dimensions of the edge.

### EXAMPLE APPROACH B i. Same as A:1.

ii. Morphologically dilate each pixel in the boundaries between FG & BG classes (as defined in A.ii.), using a structuring element (e.g. a circle) with a size proportional to the value of the scale-measure at that point. (Thus the requirement for the scale-measure process in the initial processing if this method is used.) All pixels found to be inside this dilated boundary are then assigned the Mixed/Edge/Blend status.

References:

Soille: Morphological Image Analysis by P. Soille, second edition. ISBN 3-540-42988-3
loess: http://www.itl.nist.gov/div898/handbook/pmd/section1/pmd144.htm

### EXAMPLE 2

When calculating the gradient, many methods can be used. The morphological gradient is one such appropriate method:
http://www.dca.fee.unicamp.br/projects/khoros/mmach/tutor/toolbox/firstl/grad/grad.html
http://www.ph.tn.tudelft.nl/Courses/FIP/noframes/fip-Morpholo.html#Heading106
http://bigwww.epfl.ch/demo/jmorpho/index.html

The multi-scale gradient technique allows a determination of the “feature size” by calculating several gradients for each pixel. First, the calculation of the first derivative/gradient. In this example the gradient does not have a direction, only the magnitude of the gradient at a point is calculated. For a greyscale image this is a scalar value, and for a multi-channel image it is, in general, a vector in colour/feature space. For a multi-channel image, the gradient magnitude may be calculated for each channel, and then these values combined to produce a single scalar value by various methods, e.g. the magnitude of the vector constructed in colour space by using the min and max in each channel as the endpoints in that dimension, or the maximum (or median, or mean) of the gradient-magnitude in each channel.

One example is to take a processing element (for example, a square), and to define the gradient at a pixel as (max−min)/l, where max is the highest grey level in the square, min is the lowest, and l is the side length of the square, when the square is centred on the pixel in question.

By using different sized squares, different values may be obtained for the same pixel.

For example, if we consider a pixel in the middle of the blended edge in FIG. 1, which in this example is a linear blend, the gradient magnitude calculated using any square which does not cover an area outside the blend will be the same, because a larger square will have larger max and smaller min corresponding linearly to the increase in l. If we continue to increase the size of the square beyond the edges of the blend, though, l continues to grow, but min and max remain fixed. The gradient thus decreases.

For each pixel, by increasing the size of the processing element until the gradient calculated starts to drop, and noting the size of processing element at which the drop becomes significant (to allow for noise in the data) an estimate of the “characteristic feature size” or “edge width” is found for each pixel. This measure will clearly be larger for wide edges, and smaller for sharp ones.

In this way, an image may be constructed where the value at each pixel is the “edge width” at that pixel. Any other suitable method of determining the “characteristic feature size”, or “edge width” for each pixel may be used.

Optionally, the image of edge-width values thus created may be smoothed, so that there are no sharp changes between adjacent pixels.

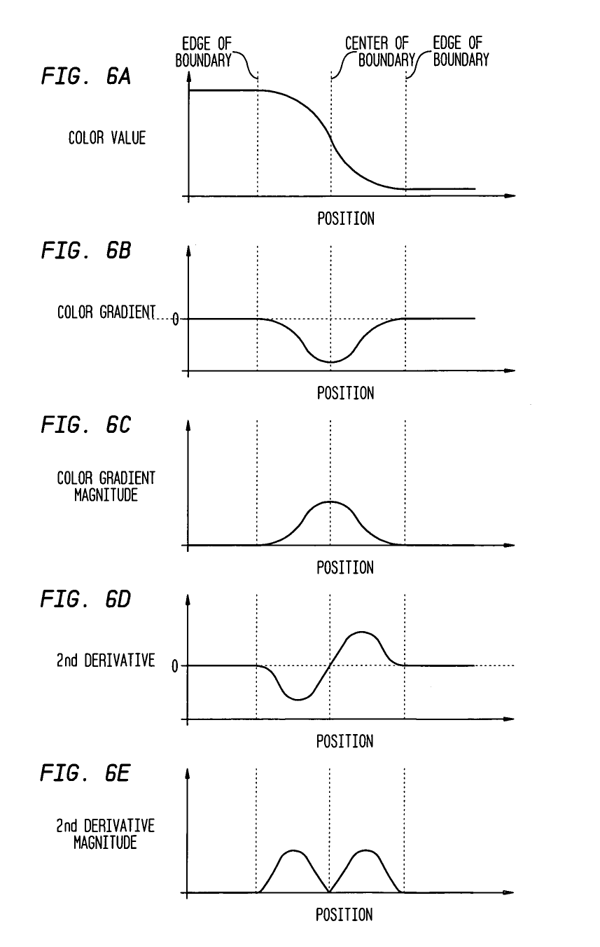

In one method according to the invention the following steps are carried out.
1. User paints a first selection (e.g. foreground)
2. System automatically expands that selection e.g. according to a predetermined automatic segmentation, or by some other method.
   Subsequent selections gain an extra edge-filling-in step after that expansion, as follows:
3. User (or system) paints a second selection, A. (or alternatively performed automatically by the system)
4. System automatically expands that selection to obtain a selection B
5. For each pixel P which is “close” to B, the edge-width e is read. What “close” means may vary: e.g. pixels which are situated within the value of e for a given pixel on the boundary of B may be examined. Alternatively, a user-provided or fixed value to decide how far from B to search may be used.
   for each P, the area around P (e.g. a square with side length l, if we stored l in the edge-width image) is searched for pixels with the complementary status of B. If any are found, that means that there is both FG and BG “close enough together” to imply that we have found a boundary area.
   Next, one of two alternative steps are performed. The first is that an area around that pixel (e.g. the square searched, or a circle diameter 1, or a square or circle of side length/diameter equal to the edge-width multiplied by some constant) is filled with “blend” status.
   The second is that this “edge pixel” is marked, and the search continues around the boundary of B until all Ps have been considered, and all the “edge” ones marked. Then, an image-space watershed is carried out on the second derivative image, seeding three classes: one with the edge-pixels we found, one with the foreground pixels, and one with the background pixels. The image space watershed on the 2^{nd} derivative will expand each class until the edge class reaches the edges of the edge, since there we find a peak (illustrated in FIG. 6).

Other alternative methods of choosing which pixels around a pixel identified as “boundary” may also be used.

1. A method for segmenting a digital image, the digital image comprising at least some mixed pixels whose visual characteristics are determined by a mixture of the visual characteristics of part of two or more portions of the image, the method comprising the steps of:
selecting one or more pixels within a first portion of the image to define a first pixel selection;
expanding the first pixel selection to define a second pixel selection corresponding to a first portion of the image;
selecting one or more pixels within a second portion of the image to define a third pixel selection;
expanding the third pixel selection to define a fourth pixel selection corresponding to a second portion of the image;
making a determination as to how close together the second pixel selection and the fourth pixel selection are; and
indicating to a user whether or not the second pixel selection and fourth pixel selection are sufficiently close that the pixels occurring in between the second pixel selection and the fourth pixel selection are pixels in a boundary portion of the image.

2. A system arranged to undertake the method of claim 1.
